(19) United States
(12) Patent Application Publication
(10) Pub. No.: US 2025/0311751 A1
(43) Pub. Date: Oct. 9, 2025

(54) PLANT-BASED FOOD PRODUCTS

(71) Applicant: Michael Foods, Inc., Hopkins, MN (US)

(72) Inventors: Alissa ROTHENBERGER, Gaylord, MN (US); Noel RUDIE, Gaylord, MN (US)

(73) Assignee: Michael Foods, Inc., Hopkins, MN (US)

(21) Appl. No.: 19/170,799

(22) Filed: Apr. 4, 2025

Related U.S. Application Data
(60) Provisional application No. 63/575,446, filed on Apr. 5, 2024.

(51) Int. Cl. A23J 3/22; A23J 3/14

(52) U.S. Cl. CPC A23J 3/227; A23J 3/14

(57) ABSTRACT

The present disclosure relates to food products that include a binding agent comprising a first plant protein and a protein source comprising a second plant protein. Other primary ingredients include starch(es), fat(s), and water. The food products can be vegan or vegetarian meat substitutes and can exhibit a satisfactory cooking experience and organoleptic texture after heating.

### CROSS-REFERENCE TO RELATED APPLICATIONS

This application claims the benefit of priority to U.S. Provisional Patent Application Ser. No. 63/575,446, filed Apr. 5, 2024, which is hereby incorporated by reference in its entirety.

### TECHNICAL FIELD

The present disclosure relates to plant-based food products. More specifically, the present disclosure relates to plant-based meat substitute products that include plant protein as a binding agent and exhibit a satisfactory cooking experience and organoleptic texture after heating.

### BACKGROUND

The demand for plant-based ingredients for vegan and vegetarian products in the growing food industry is increasing. This demand is being driven, at least in part, by consumers' increasing awareness of and interest in the transparency and sustainability of their food supply. For example, a global challenge is presented by animal-based ingredients, including food security and preservation of land and water resources due to climate change, population growth, and changing diets. Health-conscious consumers may also be concerned that animal-based ingredients can be high in fats, including saturated fats, which can raise cholesterol levels in the blood and increase the risk of heart disease. At least these reasons may be leading food industries to commercialize products formulated with plant-based ingredients.

Consumer preference studies have shown that meat-eaters are more willing to switch to plant-based foods when the products mimic meat in texture and sensorial properties and can be incorporated in a meal context that fits expectations. Focusing on this consumer segment, food producers are seeking to understand how plant-based ingredients can partially or wholly replace traditional animal-based ingredients in foods to deliver optimal nutrition, texture, flavor, and functionality. Advances in plant-based ingredient options and functionality are also in demand, as these ingredients can be combined with other ingredients to fulfill needs (e.g., color, palatability, and shelf life) in the development of plant-based food products.

However, the development, manufacturing, and marketability of plant-based foods faces several challenges. Among these are the suboptimal flavors and textures associated with replacement of animal-based or synthetic ingredients in plant-based foods with alternative plant-based ingredients. For this reason, recent meat analog research and development has focused on the production of sustainable products that recreate conventional meat, not only nutritionally, but also in its physical sensations, including texture, appearance, smell, and taste.

Currently, technologies such as extrusion and mixing are used for texturizing plant-based ingredients to form a variety of structures. The type of structure achieved is dependent on the functional properties of the plant-based and other ingredients used in the food product. For example, a typical plant-based food contains, apart from protein in textured and non-textured form, water, flavorings, oil or fat, binding agents, and coloring agents. However, many of the ingredients used in these products are synthetic or highly refined, causing meat analogs to face criticism as artificial products. For example, most commercially available vegetarian and vegan meat analog food products use methylcellulose (MC) as a binding agent. MC appears as an artificial chemical on food packaging labels and is unfriendly to consumers. Also, while MC can provide an appealing texture when freshly heated, once the product cools, the texture becomes soft or mushy to the point of being unacceptable to consumers. Accordingly, in addition to optimizing the flavor and texture of plant-based foods, producers are seeking functional, nonallergenic ingredients to replace the refined or synthetic ingredients (such as synthetic binders and emulsifiers) in plant-based food products as part of consumer demand for clean labels.

To address these issues, additives in combination with other ingredients have been used to achieve the desired physical sensations of plant-based foods, including texture, appearance, smell, and taste. For example, carbohydrate-based hydrocolloids that gel upon heating have been used as natural binding agents. However, the process to achieve gelation of these materials is rather complex, and products produced with hydrocolloids can provide a gummy mouthfeel. Starches have also been used as binding agents, but starch-based binders has a detrimental effect on texture, leading to products with a mushy sensory perception that also crumbles or crusts over when cooked. In addition, carbohydrates and starches and flours are high glycemic index ingredients, which are not recommended for specific consumer populations. There are presently no natural, plant-based binding agents that are acceptable to consumers in terms of optimal nutrition, texture, flavor, and functionality.

### SUMMARY

The present disclosure describes a solution to at least some of the problems associated with plant-based food products. The solution resides in the use of binding agents comprising, consisting of, or consisting essentially of a vegetable protein source in food product formulations. In some aspects, the vegetable protein binding agent can stabilize the stiffness and/or texture of the food product during cooking, once cooled after cooking, or both during cooking and after cooling. This texture retention is observed regardless of the method used to heat the food product, e.g., a conventional oven, a convection oven, a skillet, a fryer, an air fryer, or a microwave. The vegetable protein binding agent can be potato protein, pea protein, or a combination thereof. These vegetable proteins are all-natural, plant-based ingredients that are familiar to consumers and clean label friendly. Employing the vegetable protein binding agent with further ingredients disclosed herein can provide a food product having superior organoleptic properties compared to food products prepared with traditional binders including methylcellulose. In some aspects, the food products are substantially free of vegetable fiber. In some aspects, the food products are substantially free of hydrocolloids. In some aspects, the food products are substantially free of vegetable fiber and hydrocolloids. In some aspects, the food product does not include methylcellulose.

Accordingly, some aspects of the disclosure are directed to a food product including 5 wt. % to 15 wt. % of a binding agent comprising, consisting of, or consisting essentially of a first plant protein and a protein source comprising, consisting of, or consisting essentially of a second plant protein. In some aspects, the food product includes 5 wt. % to 15 wt. % of a binding agent comprising a first plant protein and a protein source comprising a second plant protein. In some aspects, the food product includes 5 wt. % to 15 wt. % of a binding agent comprising a first plant protein and a protein source consisting essentially of a second plant protein. In some aspects, the food product includes 5 wt. % to 15 wt. % of a binding agent comprising a first plant protein and a protein source consisting of a second plant protein. In some aspects, the food product includes 5 wt. % to 15 wt. % of a binding agent consisting essentially of a first plant protein and a protein source comprising a second plant protein. In some aspects, the food product includes 5 wt. % to 15 wt. % of a binding agent consisting essentially of a first plant protein and a protein source consisting essentially of a second plant protein. In some aspects, the food product includes 5 wt. % to 15 wt. % of a binding agent consisting essentially of a first plant protein and a protein source consisting of a second plant protein. In some aspects, the food product includes 5 wt. % to 15 wt. % of a binding agent consisting of a first plant protein and a protein source comprising a second plant protein. In some aspects, the food product includes 5 wt. % to 15 wt. % of a binding agent consisting of a first plant protein and a protein source consisting essentially of a second plant protein. In some aspects, the food product includes 5 wt. % to 15 wt. % of a binding agent consisting of a first plant protein and a protein source consisting of a second plant protein.

Also disclosed herein, in some aspects, is a method of manufacturing the food product. In some aspects, the method includes mixing 5 wt. % to 15 wt. % of a binding agent comprising, consisting of, or consisting essentially of a first plant protein with a protein source comprising, consisting of, or consisting essentially of a second plant protein. In some aspects, the method further includes casting the binding agent and protein source mixture into a form of the food product. In some aspects, the method further comprises mixing starch, fat, or a combination thereof with the protein source and the binding agent. In some aspects, the food product is a meat substitute. In some aspects, the form of the product is a patty, ball, or sausage.

In some aspects, the food product can include 5 wt. % and 15 wt. %, e.g., 6 wt. % to 14 wt. %, 7 wt. % to 13 wt. %, or 8 wt. % to 12 wt. %, or at least, at most, exactly, or between any two of 5 wt. %, 5.5 wt. %, 6 wt. %, 6.5 wt. %, 7 wt. %, 7.5 wt. %, 8 wt. %, 8.5 wt. %, 9 wt. %, 9.5 wt. %, 10 wt. %, 10.5 wt. %, 11 wt. %, 11.5 wt. %, 12 wt. %, 12.5 wt. %, 13 wt. %, 13.5 wt. %, 14 wt. %, 14.5 wt. %, or 15 wt. %, of the first plant protein. In some aspects, the first plant protein is potato protein, pea protein, or a combination thereof.

In some aspects, the food product can include 5 wt. % and 15 wt. %, e.g., 6 wt. % to 14 wt. %, 7 wt. % to 13 wt. %, or 8 wt. % to 12 wt. %, or at least, at most, exactly, or between any two of 5 wt. %, 5.5 wt. %, 6 wt. %, 6.5 wt. %, 7 wt. %, 7.5 wt. %, 8 wt. %, 8.5 wt. %, 9 wt. %, 9.5 wt. %, 10 wt. %, 10.5 wt. %, 11 wt. %, 11.5 wt. %, 12 wt. %, 12.5 wt. %, 13 wt. %, 13.5 wt. %, 14 wt. %, 14.5 wt. %, or 15 wt. %, of the second plant protein. In some aspects, the second plant protein is potato protein, pea protein, soy protein, mung bean protein, or rice protein, or any combination of potato protein, pea protein, soy protein, mung bean protein, or rice protein.

In some aspects, the food product further includes a starch. In some aspects, the starch is pea starch, corn starch, rice starch, potato starch, wheat starch, or tapioca starch, or any combination of pea starch, corn starch, rice starch, potato starch, wheat starch, or tapioca starch. In some aspects, the food product can include 0.01 wt. % to 3 wt. %, e.g., 0.05 wt. % to 2 wt. %, 0.1 wt. % to 1 wt. %, or 0.5 wt. % to 0.75 wt. %, or at least, at most, exactly, or between any two of 0.01 wt. %, 0.02 wt. %, 0.03 wt. %, 0.04 wt. %, 0.05 wt. %, 0.06 wt. %, 0.07 wt. %, 0.08 wt. %, 0.09 wt. %, 0.10 wt. %, 0.20 wt. %, 0.30 wt. %, 0.40 wt. %, 0.50 wt. %, 0.60 wt. %, 0.70 wt. %, 0.80 wt. %, 0.90 wt. %, 1.0 wt. %, 1.1 wt. %, 1.2 wt. %, 1.3 wt. %, 1.4 wt. %, 1.5 wt. %, 1.6 wt. %, 1.7 wt. %, 1.8 wt. %, 1.9 wt. %, 2.0 wt. %, 2.1 wt. %, 2.2 wt. %, 2.3 wt. %, 2.4 wt. %, 2.5 wt. %, 2.6 wt. %, 2.7 wt. %, 2.8 wt. %, 2.9 wt. %, or 3.0 wt. %, of the starch. In some aspects, the food product does not include a starch.

In some aspects, the food product further comprises one or more oil(s), one or more fat(s), one or more colorant(s), one or more flavoring(s), or water, or any combination of one or more oil(s), one or more fat(s), one or more colorant(s), one or more flavoring(s), or water. Any one or more of the foregoing ingredients may be excluded from the food products disclosed herein. In some aspects, the food product can include fat or oil in an amount of 5 wt. % to 20 wt. %, e.g., 7 wt. % to 18 wt. %, 10 wt. % to 15 wt. %, or 11 wt. % to 13 wt. %, at least, at most, exactly, or between any two of 5.0 wt. %, 5.5 wt. %, 6.0 wt. %, 6.5 wt. %, 7.0 wt. %, 7.5 wt. %, 8.0 wt. %, 8.5 wt. %, 9.0 wt. %, 9.5 wt. %, 10.0 wt. %, 10.5 wt. %, 11.0 wt. %, 11.5 wt. %, 12.0 wt. %, 12.5 wt. %, 13.0 wt. %, 13.5 wt. %, 14.0 wt. %, 14.5 wt. %, 15.0 wt. %, 15.5 wt. %, 16.0 wt. %, 16.5 wt. %, 17.0 wt. %, 17.5 wt. %, 18.0 wt. %, 18.5 wt. %, 19.0 wt. %, 19.5 wt. %, or 20.0 wt. %. In some aspects, the food product can include water in an amount of 45 wt. % to 75 wt. %, e.g., 47 wt. % to 70 wt. %, 50 wt. % to 65 wt. %, or 55 wt. % to 60 wt. %, at least, at most, exactly, or between any two of 45 wt. %, 46 wt. %, 47 wt. %, 48 wt. %, 49 wt. %, 50 wt. %, 51 wt. %, 52 wt. %, 53 wt. %, 54 wt. %, 55 wt. %, 56 wt. %, 57 wt. %, 58 wt. %, 59 wt. %, 60 wt. %, 61 wt. %, 62 wt. %, 63 wt. %, 64 wt. %, 65 wt. %, 66 wt. %, 67 wt. %, 68 wt. %, 69 wt. %, 70 wt. %, 71 wt. %, 72 wt. %, 73 wt. %, 74 wt. %, or 75 wt. %.

In some aspects, the food product includes 5 wt. % to 15 wt. % of the binding agent, 4 wt. % to 12 wt. % of the protein source, 0.01 wt. % to 3 wt. % starch, 5 wt. % to 20 wt. % fat, and 45 wt. % to 75 wt. % water. In some aspects, the food product includes 6 wt. % to 14 wt. % of the binding agent, 6 wt. % to 14 wt. % of the protein source, 0.05 wt. % to 2 wt. % starch, 7 wt. % to 18 wt. % fat, and 47 wt. % to 70 wt. % water. In some aspects, the food product includes 7 wt. % to 13 wt. % of the binding agent, 7 wt. % to 13 wt. % of the protein source, 0.10 wt. % to 1 wt. % starch, 10 wt. % to 15 wt. % fat, and 50 wt. % to 65 wt. % water. In some aspects, the food product includes 8 wt. % to 12 wt. % of the binding agent, 8 wt. % to 12 wt. % of the protein source, 0.50 wt. % to 0.75 wt. % starch, 11 wt. % to 13 wt. % fat, and 55 wt. % to 60 wt. % water.

In some aspects, the food product is substantially free of vegetable fiber (e.g., potato fiber). some aspects, the food product is substantially free of hydrocolloids. In some aspects, the food product is substantially free of vegetable fiber (e.g., potato fiber) and hydrocolloids. In some aspects, the food product is substantially free of additives. In some aspects, the food product does not include methylcellulose. In some aspects, the food product has a pH of 4.5 to 6.5 (e.g., at least, at most, exactly, or between any two of 0.5, 4.6, 4.7, 4.8, 4.9, 5.0, 5.1, 5.2, 5.3, 5.4, 5.5, 5.6, 5.7, 5.8, 5.9, 6.0, 6.1, 6.2, 6.3, 6.4, or 6.5). In some aspects, the food product has a water activity of 0.90 to 0.99 (e.g., at least, at most, exactly, or between any two of 0.90, 0.91, 0.92, 0.93, 0.94, 0.95, 0.96, 0.97, 0.98, or 0.99). In some aspects, the food product is a meat substitute. In some aspects, the food product is vegan. In some aspects, the food product is a vegan meat substitute.

The claims are not intended to include, and should not be interpreted to include, means plus- or step-plus-function limitations, unless such a limitation is explicitly recited in a given claim using the phrase(s) “means for” or “step for,” respectively.

The use of the term “or” in the claims is used to mean “and/or” unless explicitly indicated to refer to alternatives only or the alternative are mutually exclusive, although the disclosure supports a definition that refers to only alternatives and “and/or.” The phrase “and/or” means “and” or “or”. To illustrate, A, B, and/or C includes: A alone, B alone, C alone, a combination of A and B, a combination of A and C, a combination of B and C, or a combination of A, B, and C.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, the compositions and methods of the present disclosure that “comprise,” “have,” “include” or “contain” one or more elements possesses those one or more elements, but are not limited to possessing only those one or more elements. Likewise, an element of a composition or method of the present disclosure that “comprises,” “has,” “includes” or “contains” one or more features possesses those one or more features, but is not limited to possessing only those one or more features.

Any embodiment of the compositions and methods of the present disclosure can consist of or consist essentially of—rather than comprise/include/contain/have—any of the described elements and/or features and/or steps. Thus, in any of the claims, the term “consisting of” or “consisting essentially of” can be substituted for any of the open-ended linking verbs recited above, in order to change the scope of a given claim from what it would otherwise be using the open-ended linking verb. Compositions and methods “consisting essentially of” any of the elements or steps disclosed limits the scope of the claim to the specified materials or steps which do not materially affect the basic and novel characteristic of the claimed disclosure. The words “consisting of” (and any form of consisting of, such as “consist of” and “consists of”) means including, and limited to, whatever follows the phrase “consisting of.” Thus, the phrase “consisting of” indicates that the listed elements are required or mandatory, and that no other elements may be present.

As used herein, in the specification, “a” or “an” may mean one or more, unless clearly indicated otherwise. As used herein, in the claim(s), when used in conjunction with the word “comprising,” the words “a” or “an” may mean one or more than one. As used herein “another” may mean at least a second or more.

In any disclosed aspect, the terms “about” and “approximately” and “substantially” and the like may be substituted with “within [a percentage] of” what is specified. In one non-limiting aspect, the percentage includes 0.1, 0.5, 1, 5, and 10 percent.

A composition disclosed herein may be considered “substantially free” of a substance when the amount of the substance is not sufficient to materially affect the structural, functional, or chemical properties of the composition. Additionally, or alternatively, a composition disclosed herein may be considered “substantially free” of a substance when the concentration of the substance in the composition is less than 0.1 wt. %.

As used herein, unless the surrounding text explicitly indicates a contrary intention, all values given in the form of percentages are weight per weight (w/w), weight percent, or wt. %, corresponding to the proportion of a particular substance within a mixture, as measured by weight or mass.

The terms “food,” “food product,” and the like mean a product or composition that is intended for ingestion by an animal, including a human, and provides at least one nutrient to the animal or human. The present disclosure is not limited to a specific animal.

A “meat substitute” may also be referred to herein as a meat alternative, meat analogue, mock meat, faux meat, imitation meat, vegetarian meat, or vegan meat. A meat substitute is understood to mean a food made from non-meats, and without other animal products (e.g., skeletal and non-skeletal tissue from mammals, fish, or fowl) or by-products, including animal protein.

The term “plant protein” includes one or more proteins from one or more plants and includes “plant protein isolates” or “plant protein concentrates” or combination thereof.

The term “binder” or “binding agent” as used herein relates to a substance for holding together particles and/or fibers of a product in a cohesive matrix and/or for thickening the product. Binding agents of the disclosure may provide a firmer and/or smoother product texture, add body to a product, help retain moisture, and/or assist in maintaining cohesive product shape.

The term “additive” includes, but is not limited to, one or more of the following ingredients: modified starches, hydrocolloids (e.g., carboxymethylcellulose, methylcellulose, hydroxypropylmethylcellulose, konjac gum, carrageenan, xanthan gum, gellan gum, locust bean gum, alginate, agar, gum arabic, gelatin, Karaya gum, Cassia gum, microcrystalline cellulose, ethylcellulose); emulsifiers (e.g. lecithin, mono- and di-glycerides, polyglycerol polyricinoleate); whitening agents (e.g., titanium dioxide); plasticizers (e.g., glycerin); or anti-caking agents (e.g., silicon-dioxide).

It is specifically contemplated that any limitation discussed with respect to one aspect of the disclosure may apply to any other aspect of the disclosure. Furthermore, any composition of the disclosure may be used in any method of the disclosure, and any method of the disclosure may be used to produce or to utilize any composition of the disclosure. Any embodiment discussed with respect to one aspect of the disclosure applies to other aspects of the disclosure as well and vice versa. For example, any step in a method described herein can apply to any other method. Moreover, any method described herein may have an exclusion of any step or combination of steps. Aspects of an embodiment set forth in the Examples are also aspects that may be implemented in the context of embodiments discussed elsewhere in a different Example or elsewhere in the application, such as in the Summary, Detailed Description, Claims, and Brief Description of the Drawings.

Other objects, features and advantages of the present disclosure will become apparent from the following detailed description. It should be understood, however, that the detailed description and the specific examples, while indicating specific aspects of the disclosure, are given by way of illustration only, since various changes and modifications within the spirit and scope of the disclosure will become apparent to those skilled in the art from this detailed description.

### BRIEF DESCRIPTION OF THE DRAWINGS

Various features and advantageous details are explained more fully with reference to the non-limiting aspects illustrated in the accompanying drawings and detailed in the following description. It should be understood, however, that the detailed description and the specific examples, while indicating aspects of the disclosure, are given by way of illustration only, and not by way of limitation. Various substitutions, modifications, additions, and/or rearrangements will become apparent to those of ordinary skill in the art from this disclosure.

FIG. 1 is a diagram outlining exemplary method steps employed in the production of a food product as disclosed herein.

### DETAILED DESCRIPTION

As noted above, the present disclosure describes food products, such as plant-based food products (e.g., meat substitutes, vegan products) that include a binding agent comprising, consisting of, or consisting essentially of a plant protein. In some aspects, plant-based food products formulated with a binding agent comprising, consisting of, or consisting essentially of a plant protein provide advantages over conventional plant-based food products formulated with synthetic or traditional binding agents (e.g., methylcellulose). Such advantages can include, for example, structurally stabilized food products including consumer friendly, natural (i.e., not synthetic) ingredients and having improved overall quality, particularly textural quality and mouthfeel, during cooking, once cooled after cooking, or both during cooking and after cooling.

### I. Plant Protein Ingredients

Described herein are food products including plant protein. Plant proteins having the function of binding water and/or stabilizing emulsions are contemplated as being useful in the food products disclosed herein. These plant proteins include potato proteins, legume proteins (e.g., pea proteins), rice proteins, gluten, and oilseed proteins.

Protein is a major and versatile constituent of food products. Apart from the nutritional value provided by protein, the physicochemical and behavioral properties of proteins during processing play a significant role in determining the end quality of food. The structural versatility and amphiphilic nature of proteins allow proteins to interact with other food constituents, such as carbohydrates, fats, water, vitamins, minerals, and other proteins, through a range of interactions and bonds. The functional properties of protein may be dictated by structural characteristics, including the amino acid composition and sequence, molecular size, and configuration, as well as physicochemical characteristics, such as surface hydrophobicity, net charge, and presence of reactive groups (e.g., sulfhydryl and hydroxyl groups). These characteristics can be interrelated; for example, the amino acid composition affects hydrophobicity and charge, while the sequence can affect molecular configuration, which, in turn, may affect surface properties. Surface properties can affect protein solubility, thermal stability, and emulsifying and foaming properties, as well as gelation ability. For example, whey protein has very low surface hydrophobicity; therefore, it is highly soluble and is the golden standard for protein ready-to-drink beverages. On the other hand, proteins with high molecular weight and high surface hydrophobicity, such as soy protein, may form polymers under specific conditions and can, thus, be texturized to form products with textural properties similar to meat products. Changes in the protein structure during purification and/or processing can impart a significant change in functionality.

Potato proteins have good emulsification, foaming and gelation properties, which can make potato protein(s) a good texturizer. The majority of potato protein is patatin (also known as tuberin), a glycoprotein having a low thermal denaturation temperature (55-75° C.) at which it forms a gel network. Thermally-formed gels from potato protein isolates can be obtained at pH 3 to pH 7 with minimal gelation temperatures around 45-50° C., which can be beneficial for applications where a low temperature is required.

Proteins from pea, lentil, lupine, chickpea, faba bean, mung bean, and other types of beans have good emulsification, foam stabilization, and gel formation properties. These proteins can bind water and fat, and to generate a firm texture after thermal processing. The properties of pea protein can be affected by the pea cultivar, the extraction process, and the actual protein composition (e.g., the ratio of legumin to vicilin).

Soy protein may be useful due, at least in part, to their water holding, gelling, fat absorbing, and emulsifying capacities in food products. Soybeans contain a mixture of water-soluble and insoluble proteins, of which the whole aqueous extractable proteins can be separated into storage globulin and whey fractions by acidification to pH 4.5-4.8. The extractable globular proteins are classified into four protein categories 2S, 7S, 11S and 15S according to their sedimentation coefficients. The 7S (β-conglycinin) and 11S (glycinin) fractions represent more than 80% of the proteins.

Gluten, a protein found in cereal grains, has unique cohesive and viscoelastic properties that can form fibrous proteinaceous networks upon deformation and elongation of the protein. This three-dimensional network is a result of intramolecular or intermolecular disulfide protein linking. For gliadins, which are low/medium molecular weight monomeric proteins, mostly intramolecular disulfide bonds are formed, while for glutenins, intermolecular disulfide bonds are more likely. Accordingly, gluten functionality can be determined by the ratio of glutenins:gliadins. Isolation of specific protein subunits, modification of the protein during extraction (e.g., by using non-reducing and reducing conditions or hydrostatic pressure and temperature), and interaction of gluten with other compounds such as polyphenols and alkali salts can lead to varying degrees of cross-linking, which affect the eventual structure of the gluten and its solubility, foaming, and emulsifying qualities, which can be useful for different food products.

Oilseed protein including protein from rapeseed, sunflower, canola, quinoa, chia, and pumpkin, can provide emulsification and foaming characteristics and can form gels. Heating these proteins may cause protein unfolding and exposure of hydrophobic groups, which allows the formation of non-covalent interactions among the denatured protein molecules to reinforce a colloidal network upon cooling.

In some aspects, the food products disclosed herein include 5 wt. % to 15 wt. % of a binding agent comprising, consisting of, or consisting essentially one or more first plant proteins and a protein source comprising, consisting of, or consisting essentially one or more second plant proteins.

In some aspects, one or more first plant proteins is potato protein. In some aspects, the one or more first plant proteins is pea protein. In some aspects, one or more first plant proteins are potato protein and pea protein. In some aspects, the first plant protein is provided as a powder. In some aspects, the first plant protein is provided as a liquid. In some aspects, the first plant protein can stabilize the food product or can help to retain or improve the structure, texture, and/or flavor of the food product.

In some aspects, the food product can include 5 wt. % and 15 wt. %, e.g., 6 wt. % to 14 wt. %, 7 wt. % to 13 wt. %, or 8 wt. % to 12 wt. %, or at least, at most, exactly, or between any two of 5 wt. %, 5.5 wt. %, 6 wt. %, 6.5 wt. %, 7 wt. %, 7.5 wt. %, 8 wt. %, 8.5 wt. %, 9 wt. %, 9.5 wt. %, 10 wt. %, 10.5 wt. %, 11 wt. %, 11.5 wt. %, 12 wt. %, 12.5 wt. %, 13 wt. %, 13.5 wt. %, 14 wt. %, 14.5 wt. %, or 15 wt. %, of the first plant protein. In some aspects, the first plant protein is potato protein, pea protein, or a combination thereof.

In some aspects, the one or more second plant proteins are potato protein, pea protein, soy protein, mung bean protein, or rice protein, or any combination of potato protein, pea protein, soy protein, mung bean protein, or rice protein. Any one or more of the foregoing second plant proteins may be excluded from the food products disclosed herein. In certain aspects, the one or more second plant proteins is pea protein. In some aspects, the one or more second plant proteins are provided as a powder and/or a textured protein. Textured protein can be made by any appropriate method, e.g., extrusion of the second plant protein, which can change the structure of the protein to provide a fibrous, spongy matrix, similar in texture to ground meat. The textured protein can be dehydrated or non-dehydrated. Hydrated textured protein can provide a meaty or chewy texture to the product and juiciness in the final product formulation.

In some aspects, the food product can be manufactured from two or more phases, and the total concentration of the first plant protein and/or the second plant protein may be divided between these two or more phases. In some aspects, the food product can be manufactured in three phases that are separately combined and then added together. In some aspects, the food product is manufactured by mixing a first phase, a second phase, and a third phase to produce the final food product.

The total concentration of the second plant protein may be included in one or more of the phases during the manufacturing process. In some aspects, the total concentration of the second plant protein is included in only one of the phases during the manufacturing process. In some aspects, the total concentration of the second plant protein is distributed between two or more of the phases of the manufacturing process. The form of the second plant protein in each phase may be the same or different. For example, in some aspects, the second plant protein may be a powder in two or more phases. Additionally, or alternatively, in some aspects, the second plant protein may be a powder in one phase and a textured protein in a different phase. Similarly, the type of the second plant protein may be the same in each phase or the type of the second plant protein may be different in two or more phases. The second plant protein can be potato protein, pea protein, soy protein, mung bean protein, rice protein, or any combination thereof. For example, in some aspects, the second plant protein may be derived from pea protein in two or more phases. Additionally, or alternatively, in some aspects, the second plant protein may be derived from pea protein in one phase and derived from potato protein, soy protein, mung bean protein, or rice protein in a different phase. In one non-limiting example, the food product is manufactured from a first phase, a second phase, and a third phase, and the second plant protein is divided between the first phase and the second phase. In the first phase, the second plant protein can be a textured pea protein. In the second phase, the second plant protein can be a powdered pea protein.

In some aspects, the food product can include 5 wt. % and 15 wt. %, e.g., 6 wt. % to 14 wt. %, 7 wt. % to 13 wt. %, or 8 wt. % to 12 wt. %, or at least, at most, exactly, or between any two of 5 wt. %, 5.5 wt. %, 6 wt. %, 6.5 wt. %, 7 wt. %, 7.5 wt. %, 8 wt. %, 8.5 wt. %, 9 wt. %, 9.5 wt. %, 10 wt. %, 10.5 wt. %, 11 wt. %, 11.5 wt. %, 12 wt. %, 12.5 wt. %, 13 wt. %, 13.5 wt. %, 14 wt. %, 14.5 wt. %, or 15 wt. %, of the second plant protein.

In some aspects, the first plant protein is the same as the second plant protein. For example, in some aspects, the first plant protein can be potato protein and the second plant protein can be potato protein, or the first plant protein can be pea protein and the second plant protein can be pea protein. In some aspects, the first plant protein is different from the second plant protein. For example, in certain aspects, the first plant protein is potato protein, and the second plant protein is pea protein, while in other aspects, the first plant protein is potato protein, and the second plant protein is soy protein.

In some aspects, plant protein extraction and purification processes to yield plant protein isolates or concentrations may begin with oil extraction, as is the case for soybeans or oilseeds. Other initial steps in protein extraction are air classification to separate starch granules and fiber from protein bodies, or steeping as in the corn milling process, which separates the corn into its four components, germ, fiber, starch, and protein. Cleaning and initial concentration steps for protein separation are crop dependent. Following initial separation and concentration, the protein-rich fraction is further processed to produce a protein concentrate or isolate. In some aspects, a protein concentrate includes 60-80% protein. In some aspects, a protein isolate includes greater than 80% protein.

The concentrated plant proteins may include a heterogeneous mixture of different types of proteins. Therefore, purifying the protein following different methods can result in different protein profile, quality, and functionality. Protein purification methods can include membrane filtration, chromatography, salt extraction, or pH solubilization/precipitation. When pH solubilization/precipitation is utilized, the protein can be solubilized at a pH (mostly alkaline, pH>7) where the protein is most soluble but carbohydrates will precipitate post-centrifugation. To separate the protein from soluble sugars and oligosaccharides, the protein can be precipitated at its isoelectric point. The precipitate can be washed, neutralized, and spray dried. In some cases, a diafiltration step is introduced prior to drying to reduce the amount of salt. The pH of solubilization may affect functionality, color, flavor, and digestibility of the protein.

In some aspects, the plant protein is subjected to functionalization processes, including agglomeration, lecithin coating, and high-pressure homogenization. These processes can affect particle size, shape, and surface properties of the plant proteins. Agglomeration can increase particle size by forming bridges using binders, which can enhance dispersibility, as water can diffuse within the agglomerate. Lecithin coating can enhance wettability and prevent powder caking. High-pressure homogenization coupled with controlled spray drying conditions can increase the water-holding capacity and viscosity of the plant protein.

Other functionalization strategies contemplated for the plant proteins utilized in the food products disclosed herein include protein-targeted modifications to improve solubility, increase flexibility, alter the hydrophilic/lipophilic balance, or promote protein cross-linking. One commonly used protein modification is enzymatic hydrolysis. Another protein modification approach is Maillard-induced glycation. Nonthermal protein modification techniques, such as high pressure, oscillatory magnetic field, ultraviolet radiation, ozone treatment, pulsed electric fields, and, cold plasma, are also contemplated.

### II. Food Products

Disclosed herein, in some aspects, are food products including plant protein and one or more other non-plant protein ingredients. In some aspects, plant proteins are included as binding agents in the food products. In some aspects, food products formulated with a binding agent comprising, consisting of, or consisting essentially of one or more plant proteins can provide structural stability and/or desired texturization to food products. In some aspects, use of a binding agent comprising, consisting of, or consisting essentially of one or more plant proteins can provide a food product having improved overall quality, particularly textural quality and mouthfeel, during cooking, once cooled after cooking, or both during cooking and after cooling, compared to food products formulated with a non-plant protein binding agent.

In some aspects, food products are vegetarian. In some aspects, food products are vegan. In some aspects, food products are meat substitutes. The food products can include, without limitation, any food made from non-meats, and without other animal products (e.g., skeletal and non-skeletal tissue from mammals, fish. or fowl) or by-products, including animal protein. The food products can have qualities as to appearance, taste, flavor, and texture as a corresponding real meat product. For example, the food products can have the appearance taste, flavor, and texture as chicken, beef, lamb, ham, sausage, seafood, etc. In some non-limiting examples, the food product may be a substitute for bacon, hot dogs, sausage, burgers, meatballs, chicken breast, chicken nuggets, turkey breast, duck breast, cold cuts, minced meat, etc. The food product may be formed, e.g., via molding, pressing, casting, etc. In specific aspects, the food product is a sausage. In some aspects, the food product is consumer friendly and includes natural (i.e., not synthetic) ingredients. In some aspects, the food product is free or substantially free of methylcellulose, hydrocolloids, or other additives.

In some aspects, the food product has a pH of 4, 5, 6, or 7. In some aspects, the dessert product has a pH of about 5 to 6, e.g., at least, at most, exactly, or between any two of 5, 5.05, 5.1, 5.15, 5.2, 5.25, 5.3, 5.35, 5.4, 5.45, 5.5, 5.55, 5.6, 5.65, 5.7, 5.75, 5.8, 5.85, 5.9, 5.95, or 6.

In some aspects, the food product has a color defined according to the CIELab color space of the International Commission on Illumination, including a Lightness “L,” a Red/Green value “a,” and a Blue/Yellow value “b,” or a L*a*b* color. In some aspects, the food product has a Lightness “L” of 53-65, e.g., at least, at most, exactly, or between any two of 53, 53.25, 53.5, 53.75, 54, 54.25, 54.5, 54.75, 55, 55.25, 55.5, 55.75, 56, 56.25, 56.5, 56.75, 57, 57.25, 57.5, 57.75, 58, 58.25, 58.5, 58.75, 59, 59.25, 59.5, 59.75, 60, 60.25, 60.5, 60.75, 61, 61.25, 61.5, 61.75, 62, 62.25, 62.5, 62.75, 63, 63.25, 63.5, 63.75, 64, 64.25, 64.5, 64.75, or 65. In some aspects, the food product has a Red/Green value “a” of 3-8, e.g., at least, at most, exactly, or between any two of 3, 3.25, 3.5, 3.75, 4, 4.25, 4.5, 4.75, 5, 5.25, 5.5, 5.75, 6, 6.25, 6.5, 6.75, 7, 7.25, 7.5, 7.75, or 8. In some aspects, the food product has a Blue/Yellow value “b” of 17-24, e.g., at least, at most, exactly, or between any two of 17, 17.25, 17.5, 17.75, 18, 18.25, 18.5, 18.75, 19, 19.25, 19.5, 19.75, 20, 20.25, 20.5, 20.75, 21, 21.25, 21.5, 21.75, 22, 22.25, 22.5, 22.75, 23, 23.25, 23.5, 23.75, or 24. In some aspects, the color of the food product before cooking is different from the color of the food product after cooking. For example, before cooking, the food product can have a Lightness “L” of 63-65, a Red/Green value “a” of 6-6.5, and a Blue/Yellow value “b” of 16.5-20, while after cooking, the food product can have a Lightness “L” of 53-56, a Red/Green value “a” of 7-7.5, and a Blue/Yellow value “b” of 17-24.

In some aspects, the food product has a water activity that is an indicator of product stability. Water activity or “Aw” is a measurement of the energy status of the water in a system and indicates how tightly water is bound, structurally or chemically, within a substance. The lower a sample's water activity, the more tightly bound that water is within the sample. Water activity can predict safety and stability with respect to microbial growth, chemical and biochemical reaction rates, and physical properties. Water activity can be measured by equilibrating the liquid phase water in the sample with the vapor phase water in the headspace and measuring the relative humidity of the headspace. In addition to equilibrium between the liquid phase water and the vapor phase, the internal equilibrium of the sample is important. Water activity is therefore the relative humidity of air in equilibrium with a sample in a sealed chamber. The water activity of a sample can be influenced by factors that affect the binding of water including, e.g., temperature, osmotic, matric, and pressure effects, but since water activity is usually measured at atmospheric pressure, only the osmotic, temperature, and matric effects are important. In some aspects, the food product has a water activity of 0.9-1, or 0.93-0.99, or 0.95-0.97, e.g., at least, at most, exactly, or between any two of 0.90, 0.91, 0.92, 0.93, 0.94, 0.95, 0.96, 0.97, 0.98, 0.99, or 1.0.

In some aspects, the food product has a total solids content of 25% to 60%, or 30% to 55%, or 35% to 45%, e.g., at least, at most, exactly, or between any two of 25%, 30%, 35%, 40%, 45%, 50%, 55%, or 60%.

### A. Non-Plant Protein Ingredients

Non-limiting examples of non-plant protein ingredients that may be included in the food products of the disclosure include starch(es), oil(s), fat(s), colorant(s), flavoring(s), preservative(s), or water, or any combination thereof.

### 1. Starches

In some aspects, the food products disclosed herein further include one or more starches. Starches are available from a variety of botanical sources, and native and modified forms of starches are contemplated for use in food products. The starches can be natural, non-processed starches, physically processed starches, or derivatives thereof. The starches can have a bulk density of below 50 g/100 ml, e.g., a bulk density from 8-40 g/100 ml, from 10-30 g/100 ml, or from 11-20 g/100 ml. In some aspects, the one or more starches are pea starch, corn starch, rice starch, potato starch, wheat starch, or tapioca starch, or any combination(s) or derivative(s) thereof. Any one or more of the foregoing starches may be excluded from the food products disclosed herein.

In some aspects, the food product can include 0.01 wt. % to 3 wt. %, e.g., 0.05 wt. % to 2 wt. %, 0.1 wt. % to 1 wt. %, or 0.5 wt. % to 0.75 wt. %, or at least, at most, exactly, or between any two of 0.01 wt. %, 0.02 wt. %, 0.03 wt. %, 0.04 wt. %, 0.05 wt. %, 0.06 wt. %, 0.07 wt. %, 0.08 wt. %, 0.09 wt. %, 0.10 wt. %, 0.20 wt. %, 0.30 wt. %, 0.40 wt. %, 0.50 wt. %, 0.60 wt. %, 0.70 wt. %, 0.80 wt. %, 0.90 wt. %, 1.0 wt. %, 1.1 wt. %, 1.2 wt. %, 1.3 wt. %, 1.4 wt. %, 1.5 wt. %, 1.6 wt. %, 1.7 wt. %, 1.8 wt. %, 1.9 wt. %, 2.0 wt. %, 2.1 wt. %, 2.2 wt. %, 2.3 wt. %, 2.4 wt. %, 2.5 wt. %, 2.6 wt. %, 2.7 wt. %, 2.8 wt. %, 2.9 wt. %, or 3.0 wt. %, of the starch(es).

Starches can act as fillers and enhance texture via their ability to bind and retain moisture. When heated in the presence of water, gelatinization can occur when the starch granules swell, entrapping the water released from the textured protein or other components of the composition. Starch selection for food product formulation may be dependent on the needed functionality and how the product is prepared, and one of skill in the art would understand starch properties to select the appropriate starch for the food product.

### 2. Fats & Oils

In some aspects, the food products disclosed herein further include one or more fats or oils. The fats or oils can contribute to the perceived tenderness and juiciness of the product and can aid in flavor retention/release. Liquid oils can contribute lubricity and add in the consumer perception of moisture, while saturated fats more closely mimic the fatty acid profile of traditional meat and can contribute firmness to a chilled mix of the food product composition. Flaked solid fat can also add the expected appearance of marbling.

Fats or oils can be pre-emulsified and introduced together with the plant protein and other ingredients in a mixing step. Additionally, or alternatively, fat or oils can be introduced through mixing the fats or oils with the pre-processed ingredients in a cold mixing step to create the final product. Additionally, or alternatively, fats or oils can be injected into the formed food product.

In some aspects, the food product can include fat(s) or oil(s) in an amount of 5 wt. % to 20 wt. %, e.g., 7 wt. % to 18 wt. %, 10 wt. % to 15 wt. %, or 11 wt. % to 13 wt. %, at least, at most, exactly, or between any two of 5.0 wt. %, 5.5 wt. %, 6.0 wt. %, 6.5 wt. %, 7.0 wt. %, 7.5 wt. %, 8.0 wt. %, 8.5 wt. %, 9.0 wt. %, 9.5 wt. %, 10.0 wt. %, 10.5 wt. %, 11.0 wt. %, 11.5 wt. %, 12.0 wt. %, 12.5 wt. %, 13.0 wt. %, 13.5 wt. %, 14.0 wt. %, 14.5 wt. %, 15.0 wt. %, 15.5 wt. %, 16.0 wt. %, 16.5 wt. %, 17.0 wt. %, 17.5 wt. %, 18.0 wt. %, 18.5 wt. %, 19.0 wt. %, 19.5 wt. %, or 20.0 wt. %.

In some aspects, the fats or oils include vegetable oil, coconut oil, palm oil, or cocoa butter, or any combination of soy, sunflower, rapeseed, canola, corn, palm, coconut, vegetable, cocoa, and sesame oil. The right combination of fats is important to achieve a desirable succulent mouthfeel and lingering flavor, and one of skill in the art would understand fat and oil properties to select the appropriate fat(s) and/or oil(s) for the food product.

### 3. Colorants

In some aspects, the food products disclosed herein further include one or more colorants. Color may be a factor in the visual appeal of the food product. Colors in the plant-based food products may be used to mimic the red-pink color of meat in a raw state and the brown color of meat in a cooked state. A combination of heat-unstable colorants, reducing sugars, and/or heat-stable colorants may be used to produce a desired color. Thermally unstable pigments can include betanin-pigment containing beetroot powder or juice, for example. Soy leghemoglobin, a plant-based heme-containing protein, may also be used as a coloring agent in to give a “bleeding” appearance. This pigment is denatured and converted into brown color upon cooking, similar to myoglobin in meats. Reducing sugars include xylose, arabinose, galactose, mannose, dextrose, lactose, ribose, and maltose and can undergo a Maillard-type reaction with the amino group of the plant proteins during cooking to produce a brown color. When a red-pink color in the final product is desirable, heat-stable pigments or their combinations, such as annatto, turmeric, saffron, carotene, cumin, caramel color, paprika, red yeast rice powder, canthaxanthin, and astaxanthin, may be used to achieve the desired color. One of skill in the art would understand colorant properties to select the appropriate colorants for the food product.

In some aspects, the food product can include colorant(s) in an amount of 0.01 wt. % to 0.1 wt. %, e.g., 0.02 wt. % to 0.08 wt. %, 0.03 wt. % to 0.07 wt. %, or 0.04 wt. % to 0.06 wt. %, or at least, at most, exactly, or between any two of 0.01 wt. %, 0.02 wt. %, 0.03 wt. %, 0.04 wt. %, 0.05 wt. %, 0.06 wt. %, 0.07 wt. %, 0.08 wt. %, 0.09 wt. %, or 0.10 wt. %.

### 4. Flavorings

In some aspects, the food products disclosed herein further include one or more flavorings. The flavor and taste of products can be important, as they determine the overall consumer acceptability of the finished product. Savory, meaty, and metallic flavors (iron or ferrous) may be desired in meat substitute products to mimic real meat products. To attain savory and meaty flavors and aromas, reducing sugars (glucose, xylose, fructose, and ribose), amino acids (cysteine, cystine, lysine, methionine, proline, serine, threonine), vitamins (such as thiamine), nucleotides, and iron complexes (e.g., ferrous chlorophyllin or heme-containing proteins) may be used. Hydrolyzed vegetable proteins may provide chicken- or beef-like aromas and flavors. Other flavorings may include one or more salts, spices, herbs, or vegetables (e.g., onions, celery, peppers, etc.). One of skill in the art would understand flavoring properties to select the appropriate flavorings for the food product.

In some aspects, the food product can include flavoring(s) in an amount of 0.1 wt. % to 10 wt. %, e.g., 2 wt. % to 8 wt. %, 3 wt. % to 7 wt. %, or 4 wt. % to 6 wt. %, or at least, at most, exactly, or between any two of 0.1 wt. %, 0.2 wt. %, 0.3 wt. %, 0.4 wt. %, 0.5 wt. %, 0.6 wt. %, 0.7 wt. %, 0.8 wt. %, 0.9 wt. %, 1 wt. %, 2 wt. %, 3 wt. %, 4 wt. %, 5 wt. %, 6 wt. %, 7 wt. %, 8 wt. %, 9 wt. %, or 10 wt. %.

### 5. Water

In some aspects, the food products disclosed herein further include water. Water can act as a hydration medium for the different dried ingredients and as a reaction agent during processing. In extrusion processing, for example, water can determine the viscosity of the melt, participate in the chemical reactions, influence the friction, and/or act as an energy transfer medium. With increasing moisture during highly concentrated plant protein extrusion, an increase in the reaction rates of proteins has been reported. Disulfide bonds, hydrogen bonds, and hydrophobic interactions may be promoted at higher moisture levels, which can lead to a high degree of fibrous structure formation.

In addition, functional properties of the plant proteins including swelling, viscosity, gelation, emulsification, and foaming may be affected by the availability of water in the food product. In some aspects, water can hydrate the composition to aid gelation of protein matrices or protein combinations. As wells a formation of product in particular form-patty, link, crumble etc. In some aspects, water content may contribute to sensory properties such as juiciness and mouthfeel, and water can aid shaping of a product into a particular form (e.g., patties, links, crumbles, etc.). Additionally, in some aspects, water content may permit food products to be baked or cooked similarly to meat. The inclusion of water in food may also reduce ingredient costs.

In some aspects, the food product can include water in an amount of 45 wt. % to 75 wt. %, e.g., 47 wt. % to 70 wt. %, 50 wt. % to 65 wt. %, or 55 wt. % to 60 wt. %, or at least, at most, exactly, or between any two of 45 wt. %, 46 wt. %, 47 wt. %, 48 wt. %, 49 wt. %, 50 wt. %, 51 wt. %, 52 wt. %, 53 wt. %, 54 wt. %, 55 wt. %, 56 wt. %, 57 wt. %, 58 wt. %, 59 wt. %, 60 wt. %, 61 wt. %, 62 wt. %, 63 wt. %, 64 wt. %, 65 wt. %, 66 wt. %, 67 wt. %, 68 wt. %, 69 wt. %, 70 wt. %, 71 wt. %, 72 wt. %, 73 wt. %, 74 wt. %, or 75 wt. %.

### 6. Preservatives

In some aspects, the food products disclosed herein further include one or more preservatives. The one or more preservatives may be natural and may comply with clean labeling requirements. For example, preservatives may include citric acid, one or more vinegars produced from natural fermentation, or other organic acids, peptides, or salts derived from cultured fruits and/or vegetables, cultured dextrose, cultured wheat, cultured whey, cultured brown rice, etc. One of skill in the art would understand preservative properties to select the appropriate preservatives for the food product.

In some aspects, the food product can include preservative(s) in an amount of 1 wt. % to 5 wt. %, e.g., at least, at most, exactly, or between any two of 1.00 wt. %, 1.25 wt. %, 1.50 wt. %, 1.75 wt. %, 2.00 wt. %, 2.25 wt. %, 2.50 wt. %, 2.75 wt. %, 3.00 wt. %, 3.25 wt. %, 3.50 wt. %, 3.75 wt. %, 4.00 wt. %, 4.25 wt. %, 4.50 wt. %, 4.75 wt. %, or 5.00 wt. %,

### B. Methods of Manufacturing Food Products

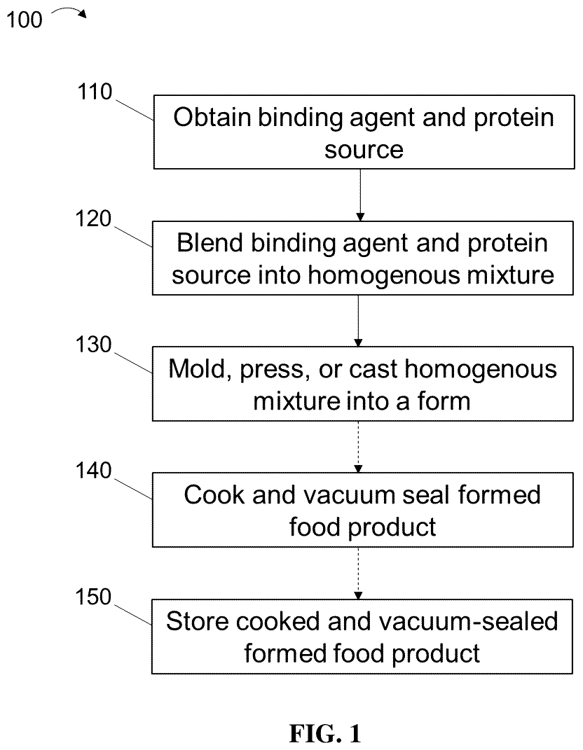

Reference is now made to FIG. 1, which is a simplified flowchart 100 of a method for producing a food product, such as a food product formulated with a binding agent comprising, consisting of, or consisting essentially of a plant protein, in accordance with an aspect of the present disclosure. In a first step 110, a binding agent comprising, consisting of, or consisting essentially of one or more first plant proteins and a protein source comprising, consisting of, or consisting essentially of one or more second plant proteins are obtained. In a second step 120, the binding agent comprising, consisting of, or consisting essentially of one or more first plant proteins and the protein source comprising, consisting of, or consisting essentially of one or more second plant proteins are mixed to form a homogenous mixture. In a third step 130, the homogenous mixture is molded, pressed, or cast into a form of the food product.

Optionally, in some aspects, the binding agent comprising, consisting of, or consisting essentially of the one or more first plant proteins is mixed with a first amount of the one or more second plant proteins, and then the resulting mixture is mixed with an additional amount of the one or more second plant proteins. The first amount of the second plant protein may be a powder, while the additional amount of the second plant protein may be a textured protein. For example, in some aspects, the binding agent comprising, consisting of, or consisting essentially of the one or more first plant proteins is mixed with the first amount of the one or more second plant proteins to form a first homogenous mixture, and the first homogenous mixture is mixed with the additional amount of the one or more second plant proteins to form a second homogenous mixture. In some aspects, the one or more second plant proteins are mixed with water. In some aspects, the one or more second plant proteins are mixed with water for a sufficient amount of time to hydrate the one or more second plant proteins (e.g., at least, at most, exactly, or between any two of 1, 2, 3, 4, 5, 10, 15, 20, 25, 30, 40, 50, 60, or more minutes), thereby providing hydrated one or more second plant proteins. In some aspects, the first homogenous mixture including the binding agent comprising, consisting of, or consisting essentially of the one or more first plant proteins is mixed with the hydrated one or more second plant proteins to form the second homogenous mixture. In some aspects, the binding agent in the first homogenous mixture comprising, consisting of, or consisting essentially of the one or more first plant proteins can compete with the one or more second plant proteins for available water and in this way, the binding agent in the first homogenous mixture comprising, consisting of, or consisting essentially of the one or more first plant proteins can coat the one or more second plant proteins. The second homogenous mixture can be molded, pressed, or cast into a form of the food product.

Optionally, in some aspects, the method can further include at step 130 mixing one or more starch(es), fat(s), colorant(s), flavoring(s), preservative(s), water, or a combination thereof with the protein source and the binding agent. The one or more starch(es), fat(s), or a combination thereof may be mixed together with the protein source and the binding agent, or the starch(es), fat(s), or a combination thereof may be mixed separately with the protein source and the binding agent. For example, one or more starch(es), colorant(s), flavoring(s), water, or a combination thereof may be mixed with the protein source and the binding agent before fat(s) are mixed with the protein source and the binding agent. The fat(s) may be room temperature or frozen and may be ground, shredded, crumbled, milled, or crushed into small pieces before mixing with the protein source and the binding agent. In this way, the food product can be made to visually resemble the marbled fat structure of real meat products. Upon cooking, the fat(s) may melt as in real meat products and thereby mimic the meat product cooking experience for consumers.

Optionally, the one or more starch(es) may be divided in one, two, three, or more portions. For example, in some aspects, the starch(es) can be provided in a first portion and a second portion. The starch of the first portion may be the same as the starch of the second portion, or the starch of the first portion may be different from the starch of the second portion. For example, in some aspects, the starch of the first portion may be derived from pea, while the starch of the second portion of may be derived from corn starch, rice starch, potato starch, wheat starch, tapioca starch, or any combination or derivative thereof. The first portion of the starch may be mixed together with the protein source before the protein source is mixed with the binding agent, and/or the second portion of the starch may be mixed together with the binding agent before the binding agent is mixed with the protein source. For example, in some aspects, the first portion of the starch is mixed with the protein source to form a first homogenous mixture, and the second portion of the starch is mixed with the binding agent comprising, consisting of, or consisting essentially of the first plant protein to form a second homogenous mixture. The first homogenous mixture can be mixed with the second homogenous mixture to form a third homogenous mixture, and the third homogenous mixture can be molded, pressed, or cast into a form of the food product.

Optionally, in some aspects, water is mixed with one or more parts of the protein source to form a first homogenous mixture, and the first homogenous mixture is mixed with the binding agent comprising, consisting of, or consisting essentially of the one or more first plant proteins to form a second homogenous mixture. The second homogenous mixture can be molded, pressed, or cast into a form of the food product. The water may be refrigerated or chilled before mixing.

Optionally, in some aspects, one or more colorant(s) and/or flavoring(s) are mixed with one or more parts of the protein source to form a first homogenous mixture, and the first homogenous mixture is mixed with the binding agent comprising, consisting of, or consisting essentially of the one or more first plant proteins to form a second homogenous mixture. The second homogenous mixture can be molded, pressed, or cast into a form of the food product.

Optionally, in some aspects, one or more preservative(s) are mixed with the binding agent comprising, consisting of, or consisting essentially of the one or more first plant proteins to form a first homogenous mixture, and the first homogenous mixture is mixed with one or more parts of the protein source to form a second homogenous mixture. The second homogenous mixture can be molded, pressed, or cast into a form of the food product.

In specific aspects, a first portion of the one or more second plant proteins of the protein source is mixed with a first portion of starch, water, colorant(s), and flavoring(s) to form a first homogenous mixture. The binding agent comprising, consisting of, or consisting essentially of the one or more first plant proteins can be mixed with a second portion of the one or more second plant proteins of the protein source, a second portion of starch, and preservative(s) to form a second homogenous mixture. The first homogenous mixture can be mixed with the second homogenous mixture to form a third homogenous mixture, which can be mixed with fat(s) to form a fourth homogenous mixture. The fourth homogenous mixture can be molded, pressed, or cast into a form of the food product.

Optionally, in some aspects, the formed food product can be cooked by heating, e.g., a conventional oven, a convection oven, a skillet, a fryer, an air fryer, or a microwave, and vacuum sealed at step 140. Alternatively, the formed food product can be vacuum sealed and cooked in a steam oven, for example. The cooked, vacuum sealed food products can be stored at step 150 at, e.g., 0° C. to −30° C. (e.g., at least, at most, exactly, or between any two of 0, −1, −2, −3, −4, −5, −6, −7, −8, −9, −10, −11, −12, −13, −14, −15, −16, −17, −18, −20, −22, −24, −26, −28, or −30° C.) for up to one day (e.g., at least, at most, exactly, or between any two of 1, 2, 3, 4, 5, 6, or 7 days), one month (e.g., at least, at most, exactly, or between any two of 1, 2, 3, or 4 weeks), or one year (e.g., 1, 2, 3, 4, 5, 6, 7, 8, 9, 10, 11, or 12 months).

### EXAMPLES

The following examples are included to demonstrate preferred embodiments of the disclosure. It should be appreciated by those of skill in the art that the techniques disclosed in the following examples represent techniques discovered by the inventor to function well in the practice of the disclosure, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention.

### Example 1

### Plant-Based Food Product Formulations

An exemplary food product including a binding agent comprising, consisting of, or consisting essentially of a plant protein, in accordance with the present disclosure, was prepared for testing. The formulation of the exemplary food product is provided at Table 1.

TABLE 1
Exemplary Formulation

| | | Supplier | |
|---|---|---|---|
| | | (Trade Name or | |
| | Ingredient | Catalog #) | % Weight |
| Part A | Water | | 57.9% |
| | Textured Protein | Roquette | 9.8% |
| | Crumble | (NUTRALYS ® TP70G) | |
| | Starch | Roquette | 0.1% |
| | | (Pea Starch N-735) | |
| | Seasoning Blend | Givuadan | 5.7% |
| | | (WB-0420-677-7) | |
| | Color | Sensient | |
| | | (Grey Blend NF CSL71476) | |
| | Black Pepper | Elite Spice Inc. | |
| | | (PB9407) | |
| | Salt | Morton Salt | |
| | | (HG 1133/2059) | |
| Part B | Binding Agent | Avebe | 9.00% |
| | | (SOLANIC ® 200) | |
| | Protein Powder | Ingredion | 3.00% |
| | | (VITESSENCE ® Pulse 1853) | |
| | Starch | Cargill | 0.6% |
| | | (POLARTEX ® 06727) | |
| | Preservative 1 | Third Wave Bioactives | 1.9% |
| | | (BIOVONTAGE ® 2447) | |
| | Preservative 2 | Third Wave Bioactives | |
| | | (REFRESH ™ 386) | |
| | Citric Acid | Cargill | |
| | Solution (50%) | | |
| Part C | Fat | Crisco | 12.00% |
| | | (Coconut) | |

| | |
|---|---|
| Total | 100.00% |

An exemplary method for preparing plant-based food products based on the above formulations is summarized in FIG. 1 and is described elsewhere herein. Briefly, the ingredients of Part A were mixed to form a first homogenous mixture; the ingredients of Part B were mixed to form a second homogenous mixture; the first homogenous mixture was mixed with the second homogenous mixture to form a third homogenous mixture; and the third homogenous mixture was mixed with the oil of Part C to form the final product mix. The final product mix was formed by molding, pressing, or casting the mix into a patty form having the appropriate target weight and dimensions. The formed patty was cooked and vacuum sealed, and the cooked and vacuum sealed patty was stored frozen. For subsequent testing, the formed, frozen patties were pan fried.

The exemplary food product formulation exhibited the physical characteristics shown in Table 2.

TABLE 2
Food Product Characteristics

| Characteristic | Value |
|---|---|
| pH | 5.00-5.96 |

| Color | | Uncooked | Cooked |
|---|---|---|---|
| | L | 63.42-64.42 | 53.85-55.65 |
| | a | 6.07-6.15 | 7.09-7.15 |
| | b | 16.91-19.75 | 17.84-17.81 |

| | |
|---|---|
| Water Activity | 0.95-0.97 |
| Solids | 35-45% |

Also prepared were food products in which the amount of plant protein binding agent in the exemplary formulation (e.g., potato protein) was varied. Formulations including 4.0 wt. % plant protein binding agent, 6.0 wt. % plant protein binding agent, 8.0 wt. % plant protein binding agent, 9.0 wt. % plant protein binding agent, 12.0 wt. % plant protein binding agent, and 14.0 wt. % plant protein binding agent were prepared and tested in addition to the exemplary formulation including 9.00 wt. % plant protein binding agent.

Also prepared were food products in which the plant protein binding agent in the exemplary formulation (i.e., potato protein) was replaced with other plant protein-based binding agents (e.g., pea protein, mung bean protein, faba protein, gelatin protein), plant gum-based binding agents (e.g., Konjac xanthan blend, guar, xanthan, carrageenan, pectin, Konjac agar blend, or Konjac), or non-plant-based synthetic binding agents (e.g., methylcellulose). The suppliers and amounts of these alternative binding agent ingredients used to replace the plant protein binding agent of the exemplary formulation are provided at Table 3.

TABLE 3
Binding Agent Alternatives

| | Supplier | |
|---|---|---|
| Ingredient | (Trade Name) | % Weight |
| Pea Protein | Roquette | 9 |
| | (NUTRALYS ® S85 Plus D) | |
| Pea Protein | Roquette | 9 |
| | (NUTRALYS ® B85F) | |
| Mung Bean Protein | Scoular | 9 |
| Faba Protein | CK Ingredients | 9 |
| | (FABAFUEL ™) | |
| Gelatin | Gelita | 9 |
| Konjac Xanthan Blend | Ingredion | 1 |
| | (TICAGEL ® Bind-KX) | |
| Guar | Ingredion | 1 |
| | (TIC ® Gum Guar) | |
| Xanthan | Ingredion | 1 |
| | (TICAXAN ® Xanthan) | |
| Carrageenan | Ingredion | 1 |
| | (TICALOID ® 710 H Powder) | |
| Pectin | Ingredion | 2 |
| | (TIC PRETESTED ® Pectin LM | |
| | 35) | |
| Konjac Agar Blend | Ingredion | 1 |
| | (TICAGEL ® Bind 55-AK) | |
| Konjac | Ingredion | 1 |
| | (TICAGEL ® Konjac High | |
| | Viscosity) | |
| Methylcellulose | Ingredion | 1.8 |
| | (TICACEL ® HV) | |

Methods for preparing the food products in which the plant protein binding agent in the exemplary formulation was replaced with other plant protein-based binding agents, gums, or non-plant protein-based binding agents were identical to methods for preparing the exemplary formulation food product so as to directly determine the influence of the plant protein binding agent ingredient versus other binding agents on the resulting food product.

### Example 2

### Organoleptic Effects of % Binding Agent

Sensory evaluation was carried out by asking consumer (untrained) panelists to taste samples of food products prepared with varying amounts of plant protein binding agent (e.g., potato protein) and to provide their feedback regarding the organoleptic attributes of the prepared food products using the organoleptic 8-point Hedonic scale of Table 4. Key organoleptic attributes used to develop the organoleptic 8-point Hedonic scale were mushiness, firmness, stickiness, fattiness, moistness, and crumbliness. An ideal score for the prepared food products was 5.0, corresponding to moderate firmness.

TABLE 4
Organoleptic 8-Point Hedonic Scale

| Score | Attributes |
|---|---|
| 1 | Soft, mushy, very sticky |
| 2 | Moderate softness, mushiness, stickiness to teeth |
| 3 | Slight softness, mushiness, stickiness to teeth |
| 4 | Slight firmness upon chew |
| 5 | Moderate firmness, balanced fat coating and moistness |
| 6 | Firm upon chewing, slight fat coating, balanced moistness |
| 7 | Moderate firmness, dryness, chalkiness, crumbliness |
| 8 | Dry, chalky, and crumbly |

In addition to evaluating test food products prepared with varying amounts of plant protein binding agent (e.g., potato protein), panelists also evaluated a control food product prepared with methylcellulose as a binding agent.

Panelists evaluated the test and control food products both (1) immediately after cooking (“Initial”) and (2) after the food products were held at room temperature for about 10 minutes (“Held”). Sensory evaluation results for the prepared food products based on the organoleptic 8-point Hedonic scale are summarized below in Table 5. Food products with a score below 4 were deemed too soft, while food products with a score of 5 were deemed ideal.

TABLE 5
Organoleptic Scores Based On % Binding Agent

Score

| % Binding Agent | Initial | Held |
|---|---|---|
| 4.0 wt. % plant protein | 1.5 | 1 |
| 6.0 wt. % plant protein | 1.5 | 1.5 |
| 8.0 wt. % plant protein | 3 | 2.5 |
| 9.0 wt. % plant protein | 5 | 4.5 |
| 12.0 wt. % plant protein | 6 | 4 |
| 14.0 wt. % plant protein | 7 | 6 |
| 1.8 wt. % methylcellulose | 4.5 | 1.5 |

The results of the sensory evaluation indicated that, as the percentage of plant protein binding agent increased, the sensory texture descriptors improved. The addition of increasing amounts of protein improved the stiffness of food product and contributed to the desired chewy texture of meat products. Sensory analysis also showed that food products prepared with 9-14 wt. % of a plant protein binding agent had better scores compared to food products prepared with methylcellulose, especially after holding the food products at room temperature for about 10 minutes after cooking. After a 10 minute hold at room temperature, scoring for food products prepared with methylcellulose as the binding agent decreased to 1.5. Based on these findings, about 9-14 wt. % of a plant protein binding agent provides a food product with a desirable texture, within the ideal range of sensory scores.

### Example 3

### Organoleptic Effects of Binding Agent Identity

Sensory evaluation was carried out by asking consumer (untrained) panelists to taste samples of food products prepared with the plant protein of the exemplary food product formulation (i.e., potato protein) or various other plant protein or plant gum binding agents and to provide their feedback regarding the organoleptic attributes of the prepared food products using the organoleptic 8-point Hedonic scale of Table 4. Key organoleptic attributes used to develop the organoleptic 8-point Hedonic scale were mushiness, firmness, stickiness, fattiness, moistness, and crumbliness. An ideal score for the prepared food products was 5.0, corresponding to moderate firmness. Sensory evaluation results for the prepared food products based on the organoleptic 8-point Hedonic scale are summarized below in Table 6.

TABLE 6
Organoleptic Scores Based On Binding Agent Identity

| Binding Agent | Score |
|---|---|
| Pea Protein 1 | 0 |
| Pea Protein 2 | 0 |
| Mung Bean Protein | 0 |
| Faba Protein | 0 |
| Gelatin Protein | 0 |
| Konjac Xanthan Blend | 1 |
| Guar | 0 |
| Xanthan | 0 |
| Carrageenan | 1 |
| Pectin | 0.5 |
| Konjac Agar Blend | 0 |
| Konjac | 0 |
| Potato Protein | 4 |

The results of the sensory evaluation indicated that food products prepared with potato protein as a binding agent had the best texture scores, exhibiting some firmness upon chewing. The other plant protein-based binding agents yielded food products that each scored 0. Plant gum-based binding agents had varying effects on texture, with the Konjac Xanthan Blend and carrageenan gums both achieving a score of 1, while the Konjac Agar Blend and pectin achieved a score of 0.5. Based on these findings, potato protein binding agent provides a food product with a desirable texture, within the ideal range of sensory scores.

The above specification and examples provide a complete description of the structure and use of illustrative embodiments. Although certain aspects have been described above with a certain degree of particularity, or with reference to one or more individual aspects, those skilled in the art could make numerous alterations to the disclosed aspects without departing from the scope of this disclosure. As such, the various illustrative aspects of the methods and systems are not intended to be limited to the particular forms disclosed. Rather, they include all modifications and alternatives falling within the scope of the claims, and aspects other than the one shown may include some or all of the features of the depicted embodiment. For example, elements may be omitted or combined as a unitary structure, and/or connections may be substituted. Further, where appropriate, aspects of any of the examples described above may be combined with aspects of any of the other examples described to form further examples having comparable or different properties and/or functions, and addressing the same or different problems. Similarly, it will be understood that the benefits and advantages described above may relate to one aspect or may relate to several aspects.

1. A food product comprising:
5 wt. % to 15 wt. % of a binding agent comprising a first plant protein; and
a protein source comprising a second plant protein.

2. The food product of claim 1, wherein the food product includes 8 wt. % to 12 wt. % of the first plant protein.

3. The food product of claim 1, wherein the first plant protein is potato protein, pea protein, or a combination thereof.

4. The food product of claim 1, further comprising a starch.

5. The food product of claim 4, wherein the starch is pea starch, corn starch, rice starch, potato starch, wheat starch, tapioca starch, or a combination thereof.

6. The food product of claim 4, wherein the food product includes 0.01 wt. % to 3 wt. % starch.

7. The food product of claim 1, wherein the food product is substantially free of vegetable fiber, hydrocolloids, or a combination thereof.

8. The food product of claim 1, wherein the food product includes 5 wt. % to 15 wt. % of the second plant protein.

9. The food product of claim 1, wherein the second plant protein is potato protein, pea protein, soy protein, mung bean protein, rice protein, or a combination thereof.

10. The food product of claim 1, further comprising oil(s), fat(s), colorant(s), flavoring(s), water, or a combination thereof.

11. The food product of claim 10, wherein the food product includes 5 wt. % to 20 wt. % fat, 45 wt. % to 75 wt. % water, or a combination thereof.

12. The food product of claim 1, wherein the food product includes:
5 wt. % to 15 wt. % of the binding agent;
4 wt. % to 12 wt. % of the protein source;
0.01 wt. % to 3 wt. % starch;
5 wt. % to 20 wt. % fat; and
45 wt. % to 75 wt. % water.

13. The food product of claim 1, wherein the food product has a pH of 4.5 to 6.5.

14. The food product of claim 1, wherein the food product has a water activity of 0.90 to 0.99.

15. The food product of claim 1, wherein the food product is a meat substitute, vegan, or a combination thereof.

16. A method of manufacturing a food product, the method comprising:
mixing 5 wt. % to 15 wt. % of a binding agent comprising a first plant protein with a protein source comprising a second plant protein; and
casting the mixture into a form of the food product.

17. The method of claim 16, further comprising mixing starch, fat, or a combination thereof with the protein source and the binding agent.

18. The method of claim 17, wherein the food product comprises 0.01 wt. % to 3 wt. % starch, 5 wt. % to 20 wt. % fat, or a combination thereof.

19. The method of claim 16, wherein the food product is substantially free of vegetable fiber, hydrocolloids, or a combination thereof.

20. The method of claim 16, wherein the food product is a meat substitute, and wherein the form of the product is a patty, ball, or sausage.
